(19) United States
(12) Patent Application Publication
(10) Pub. No.: US 2026/0063211 A1
(43) Pub. Date: Mar. 5, 2026

(54) VALVE FOR A FLUID SYSTEM OF A VEHICLE

(71) Applicant: HELLA GmbH & Co. KGaA, Lippstadt (DE)

(72) Inventor: Sebastian TIEMEYER, Dortmund (DE)

(73) Assignee: HELLA GmbH & Co. KGaA, Lippstadt (DE)

(21) Appl. No.: 19/383,884

(22) Filed: Nov. 10, 2025

Related U.S. Application Data
(63) Continuation of application No. PCT/EP2024/060351, filed on Apr. 17, 2024.

(30) Foreign Application Priority Data
May 9, 2023 (DE) 10 2023 112 090.5

(51) Int. Cl. F16K 11/085; B60R 16/08

(52) U.S. Cl. CPC F16K 11/0856; B60R 16/08

(57) ABSTRACT

A valve for a fluid system of a vehicle, comprising: a valve housing having a base, a top, and having a multiplicity of valve housing openings. A valve body is arranged so as to be rotatable and has a first level that has at least one first connecting passage, and having a second level that is separated from the first level by an intermediate base and has at least one second connecting passage for fluidically connecting at least two valve housing openings. A valve seal is arranged between the valve housing and body. A valve actuating device, wherein one of the first and/or second connecting passages is designed such that at least three valve housing openings associated with the same level as this connecting passage can be fluidically connected to one another by means of this connecting passage as a function of a switching state of the valve.

This nonprovisional application is a continuation of International Application No. PCT/EP2024/060351, which was filed on Apr. 17, 2024, and which claims priority to German Patent Application No. 10 2023 112 090.5, which was filed in Germany on May 9, 2023, and which are both herein incorporated by reference.

### BACKGROUND OF THE INVENTION

### Field of the Invention

The present invention relates to a valve for a fluid system of a vehicle.

### Description of the Background Art

Valves for fluid systems of vehicles are known. The known valve for a fluid system of a vehicle may have: a valve housing having a base, a top, and having a multiplicity of valve housing openings arranged in a side wall of the valve housing; a valve body arranged in the valve housing so as to be rotatable about a rotational axis and having, arranged perpendicular to the rotational axis, a first level that has at least one first connecting passage, and having, arranged perpendicular to the rotational axis, a second level that is separated in terms of flow from the first level by an intermediate base and that has at least one second connecting passage, in each case for the purpose of fluidically connecting at least two valve housing openings of the multiplicity of valve housing openings; a valve seal that is arranged between the valve housing and the valve body and has valve seal openings corresponding to the valve housing openings; and a valve actuating device for automatically rotating the valve body about the rotational axis.

This is the starting point for the present invention.

### SUMMARY OF THE INVENTION

It is therefore an object of the present invention is to improve a valve for a fluid system of a vehicle.

This object is attained by a valve for a fluid system of a vehicle, which is characterized in that one of the at least one first and/or at least one second connecting passages is designed such that at least three valve housing openings associated with the same level as this connecting passage can be fluidically connected to one another by means of this connecting passage as a function of a switching state of the valve.

An important advantage of the valve according to the invention is, in particular, that a valve for a fluid system of a vehicle is improved. On account of the design according to the invention of the valve for a fluid system of a vehicle, the valve is substantially simplified in terms of design, manufacturing, and switching. At the same time, the functionality of the valve according to the invention for a fluid system of a vehicle is comparable to the functionality of far more complex valves or the use of a multiplicity of simpler valves.

The valve according to the invention for a fluid system of a vehicle can be freely chosen within broad suitable limits in terms of type, mode of operation, material, and dimensioning. The potential applications of the valve according to the invention are correspondingly diverse. Strictly by way of example, reference is made here only to thermal management systems of electric vehicles, in particular to their coolant systems.

Three valve housing openings in total can be associated with the level, preferably in that these three valve housing openings are associated only with the level. In this way, an example of the invention is specified that is relatively simple in terms of design and manufacturing but that nevertheless makes it possible to implement a large number of switching states of the valve according to the invention.

The connecting passage can be delimited by at least one valve body wall, preferably that the at least one valve body wall is designed as three valve housing walls in total. The connecting passage can be implemented in a manner that is especially simple in terms of design and manufacturing by this means. This is particularly true for the example of this improvement.

An advantageous improvement of the example valve according to the invention provides that the connecting passage is separated in terms of flow from at least one other connecting passage of the level by means of at least one of the at least one valve body walls, preferably that the valve body and the intermediate base are designed such that the connecting passage and/or the other connecting passage form/forms a fluidic connection between the first level and the second level. In this way, the construction effort in manufacturing the valve according to the invention is significantly reduced while at the same time functionality of the valve according to the invention is improved. The example of this improvement additionally has the further advantage that a fluidic connection is also produced between the two levels by means of the connecting passage and/or the other connecting passage.

An advantageous improvement provides that, on the one hand, at least one valve housing opening, preferably four valve housing openings, and at least one first connecting passage, preferably three first connecting passages, can be associated with the first level, especially preferably that the three first connecting passages are separated from one another in terms of flow only by a single valve body wall, and on the other hand, at least three valve housing openings and at least two connecting passages are associated with the second level, preferably that the second connecting passages are separated only by a single valve body wall. An example of the valve according to the invention that is very advantageous in practice is specified by this means.

Another advantageous improvement provides that the valve body and the intermediate base can be designed such that one of the first connecting passages and one of the second connecting passages are designed as a single, common connecting passage. In this way, a fluidic connection between the first level and the second level can be implemented in a manner that is very simple in terms of design and manufacturing.

A further advantageous improvement of the valve provides that a multiplicity of switching states can be implemented by means of the valve, preferably that at least five switching states can be implemented, especially preferably that a transition of the valve from the first switching state ascending numerically to a sixth switching state takes place stepwise or steplessly, in each case by means of a rotation of the valve body in a first direction of rotation by 36°, and a transition of the valve from the sixth switching state directly to the first switching state takes place through a rotation of the valve body in this first direction of rotation by 180°. A multiplicity of fluidic connections solely by means of the valve according to the invention is made possible by this means. The example of this improvement furthermore has the advantage that a sufficiently large spacing between the adjacent valve housing openings is present on the one hand, and on the other hand the transition between the individual switching states can take place rapidly enough.

An advantageous improvement provides that the following valve housing openings are fluidically connected to one another in the first switching state: a valve housing opening A associated with the first level to a valve housing opening B associated with the first level, a valve housing opening C associated with the first level to a valve housing opening D associated with the first level, a valve housing opening E associated with the second level to valve housing openings F and G likewise associated with the second level.

Alternatively, an advantageous improvement provides that the following valve housing openings can be fluidically connected to one another in the second switching state: a valve housing opening B associated with the first level to a valve housing opening D likewise associated with the first level, a valve housing opening E associated with the second level to a valve housing opening G likewise associated with the second level.

The following valve housing openings can be fluidically connected to one another in the third switching state: a valve housing opening B associated with the first level to a valve housing opening D likewise associated with the first level, a valve housing opening C associated with the first level to a valve housing opening G associated with the second level, a valve housing opening E associated with the second level to a valve housing opening F likewise associated with the second level.

The following valve housing openings can be fluidically connected to one another in the fourth switching state: a valve housing opening A associated with the first level to a valve housing opening B likewise associated with the first level, a valve housing opening C associated with the first level to a valve housing opening D likewise associated with the first level, a valve housing opening E associated with the second level to a valve housing opening F likewise associated with the second level.

The following valve housing openings can be fluidically connected to one another in the fifth switching state: a valve housing opening A associated with the first level to a valve housing opening E associated with the second level, a valve housing opening C associated with the first level to a valve housing opening D likewise associated with the first level, a valve housing opening F associated with the second level to a valve housing opening G likewise associated with the second level.

The following valve housing openings can be fluidically connected to one another in the sixth switching state: a valve housing opening A associated with the first level to a valve housing opening E associated with the second level, a valve housing opening B associated with the first level to a valve housing opening D likewise associated with the first level.

In this way, a multiplicity of practice-relevant interconnections of valve housing openings, and thus of fluid lines connected thereto, is made possible. Accordingly, it is possible, for example, to implement simpler coolant systems as well as more complex coolant systems such as are required, for instance, in modern electric vehicles, by means of only a single valve, namely the valve according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a is an example of the valve according to the invention in a fluid system of a vehicle, in a first switching state of the valve, in a schematic diagram of the process,

FIG. 1b shows the example from FIG. 1a with the two levels of the valve in individual views, in a cross section through the respective level in each case,

FIG. 2a shows the example in a second switching state of the valve, in an analogous representation to FIG. 1a,

FIG. 2b shows the example in the second switching state of the valve, in an analogous representation to FIG. 1b,

FIG. 3a shows the example in a third switching state of the valve, in an analogous representation to FIG. 1a,

FIG. 3b shows the example in the third switching state of the valve, in an analogous representation to FIG. 1b,

FIG. 4a shows the example in a fourth switching state of the valve, in an analogous representation to FIG. 1a,

FIG. 4b shows the example in the fourth switching state of the valve, in an analogous representation to FIG. 1b,

FIG. 5a shows the example in a fifth switching state of the valve, in an analogous representation to FIG. 1a,

FIG. 5b shows the example in the fifth switching state of the valve, in an analogous representation to FIG. 1b,

FIG. 6a shows the example in a sixth switching state of the valve, in an analogous representation to FIG. 1a, and

FIG. 6b shows the example in the sixth switching state of the valve, in an analogous representation to FIG. 1b.

### DETAILED DESCRIPTION

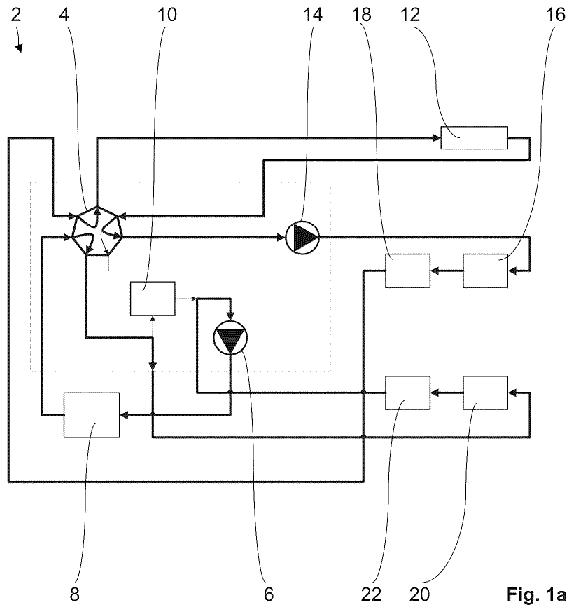

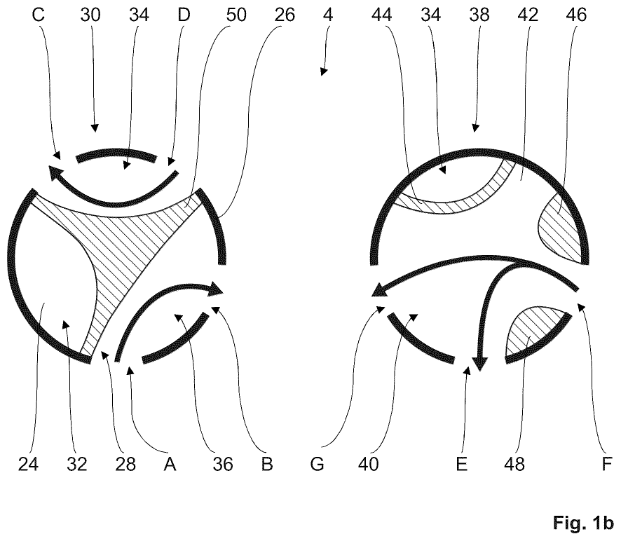

Shown strictly by way of example in FIGS. 1a to 6b is an example of the valve according to the invention for a fluid system of a vehicle.

The vehicle is designed as an electric vehicle and is not shown in detail. The fluid system 2 is designed as a coolant system for the electric vehicle and has the valve 4 as the sole valve. In addition to the valve 4, the fluid system 2 in the present example comprises: a first coolant pump 6; a traction battery 8; a coolant tank 10; a front radiator 12; a second coolant pump 14; power electronics 16 and an electric motor 18 that works together with the power electronics 16 in a manner known per se to the person skilled in the art, namely working together as a so-called drive train, for driving the vehicle; an auxiliary electric heater 20; and a chiller 22. The components represent a coolant system of a vehicle purely by way of example here. Alternatively or additionally, the coolant system can also contain other components in other examples. The person skilled in the art will make the appropriate choice of components according to the requirements of the individual case. Of course, the valve according to the invention fundamentally can also be used advantageously for other fluid systems of a vehicle.

The valve 4 for the fluid system 2 comprises: a valve housing having a base 24, a top that is not shown, and a multiplicity of valve housing openings A, B, C, D, E, F, G arranged in a side wall 26 of the valve housing; a valve body 28 arranged in the valve housing so as to be rotatable about a rotational axis extending perpendicular to the respective image plane of FIGS. 1a to 6b and having, arranged perpendicular to the rotational axis, a first level 30 that has at least one first connecting passage 32, 34, 36 and having, arranged perpendicular to the rotational axis, a second level 38 that has at least one second connecting passage 34, 40, in each case for the purpose of fluidically connecting at least two valve housing openings A to G of the multiplicity of valve housing openings A to G; a valve seal (not shown) that is arranged between the valve housing and the valve body 28 and has valve seal openings corresponding to the valve housing openings A to G; and a valve actuating device, likewise not shown, for automatically rotating the valve body 28 about the rotational axis. The first level 30 and the second level 38 are separated from one another in terms of flow by means of an intermediate base 42. The valve body 28 and the intermediate base 42 are designed here in such a manner that one of the first connecting passages and one of the second connecting passages are designed as a single, common connecting passage 34. See especially FIGS. 1b, 2b, 3b, 4b, 5b, and 6b in this regard. In each of these figures, a cross section through the first level 30 is depicted in the image plane on the left and a cross section through the second level 38 on the right. In the present example, the second level 38 is arranged above the first level 30. This is not mandatory, however, so in other examples of the invention the first level can also be arranged above the second level. In addition, the valve housing openings A to G in the respective image plane in FIGS. 1a to 6b can also be mirror-imaged in their arrangement. Analogously, the connecting passages 32, 34, 36, and 40 would then also be mirror-imaged.

According to the invention, one of the at least one second connecting passages, namely the second connecting passage 40, is designed such that at least three valve housing openings E, F, G associated with the same level as this connecting passage 40, namely the second level 38, can be fluidically connected to one another by means of this connecting passage 40 as a function of a switching state of the valve 4.

As already explained above, three valve housing openings E, F, G in total are associated with the level, namely the second level 38, wherein these three valve housing openings E, F, G in the present example are associated only with the level 38. Furthermore, the connecting passage 40 is delimited by at least one valve body wall, wherein the at least one valve body wall is designed here as three valve housing walls 44, 46, 48 in total. In addition, the connecting passage 40 is separated in terms of flow from at least one other connecting passage, namely the connecting passage 34, of the level, namely the second level 38, by means of at least one of the at least one valve body walls, namely only the valve body wall 44, wherein the valve body 28 and the intermediate base 42 are designed such that the other connecting passage 34 forms a fluidic connection between the first level 30 and the second level 38.

As likewise already explained above, at least one valve housing opening, namely four valve housing openings A, B, C, D, and at least one first connecting passage, namely three first connecting passages 32, 34, 36, are associated with the first level 30, wherein the three first connecting passages 32, 34, 36 here are separated from one another in terms of flow only by a single valve body wall 50.

The mode of operation of the valve according to the invention in accordance with the present example is explained in detail below on the basis of FIGS. 1a to 6b.

A multiplicity of switching states, namely six switching states, can be implemented by means of the valve 4, wherein a transition of the valve 4 from the first switching state ascending numerically to the sixth switching state takes place stepwise or steplessly, in each case by means of a rotation of the valve body 28 in a first direction of rotation by 36°, and a transition of the valve 4 from the sixth switching state directly to the first switching state takes place through a rotation of the valve body 28 in this first direction of rotation by 180°. This first direction of rotation corresponds, in FIGS. 1a to 6b, to a rotation of the valve body 28 in the respective image plane in the counterclockwise direction about the rotational axis.

In the first switching state, the following valve housing openings are fluidically connected to one another: the valve housing opening A associated with the first level 30 to the valve housing opening B associated with the first level 30, the valve housing opening C associated with the first level 30 to the valve housing opening D associated with the first level 30, the valve housing opening E associated with the second level 38 to the valve housing openings F and G likewise associated with the second level 38. See FIGS. 1a and 1b in this regard.

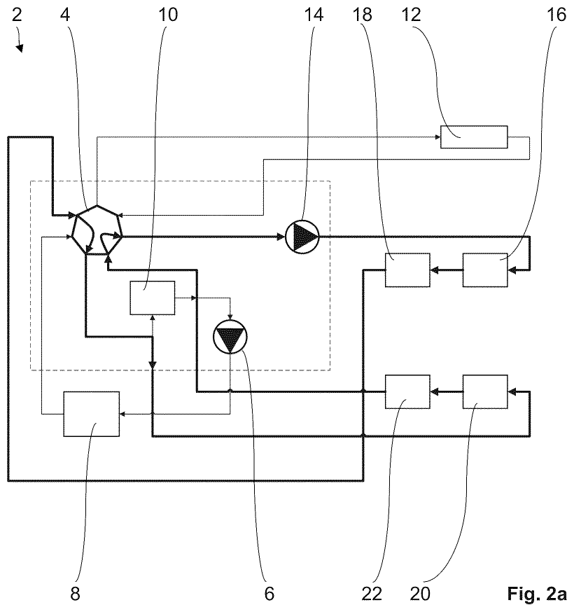

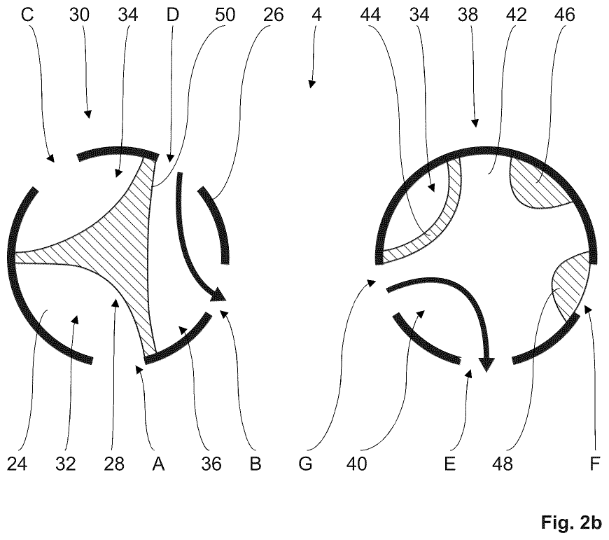

In the second switching state, the following valve housing openings are fluidically connected to one another: the valve housing opening B associated with the first level 30 to the valve housing opening D likewise associated with the first level 30, the valve housing opening E associated with the second level 38 to the valve housing opening G likewise associated with the second level 38. See FIGS. 2a and 2b in this regard.

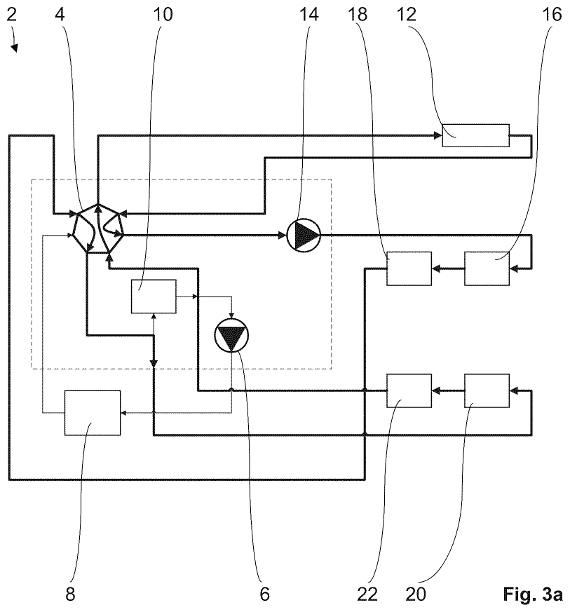

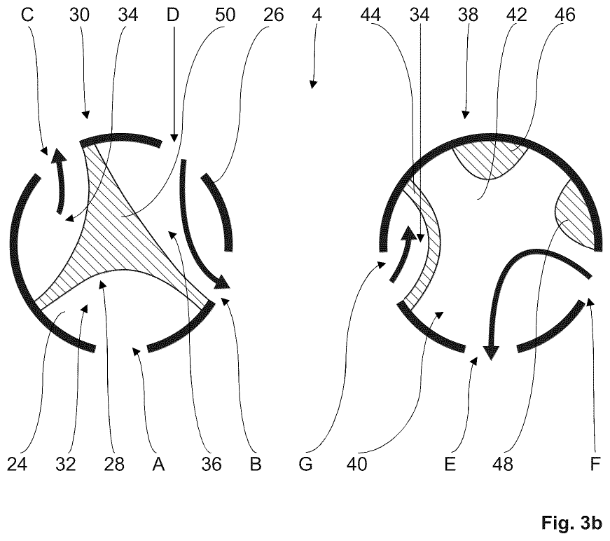

In the third switching state, the following valve housing openings are fluidically connected to one another: the valve housing opening B associated with the first level 30 to the valve housing opening D likewise associated with the first level 30, the valve housing opening C associated with the first level 30 to the valve housing opening G associated with the second level 38, the valve housing opening E associated with the second level 38 to the valve housing opening F likewise associated with the second level 38. See FIGS. 3a and 3b in this regard.

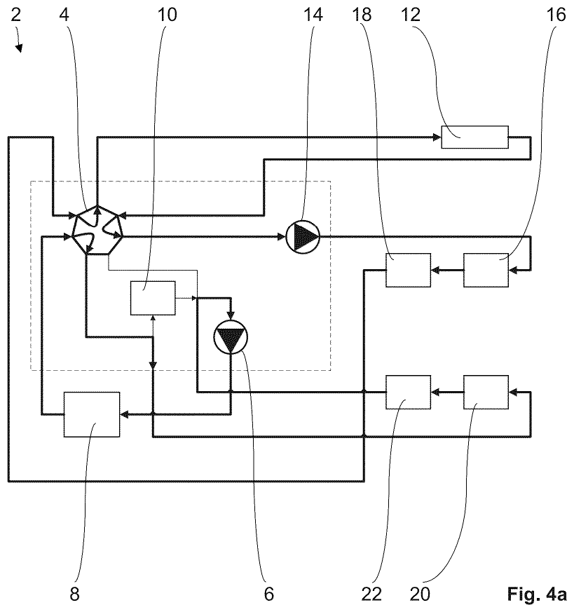

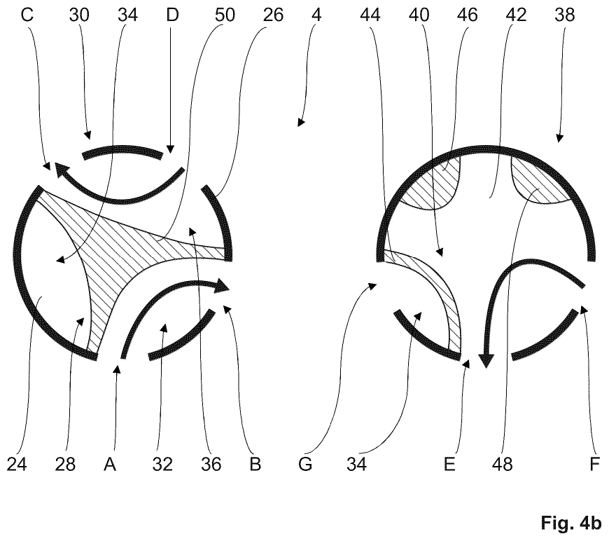

In the fourth switching state, the following valve housing openings are fluidically connected to one another: the valve housing opening A associated with the first level 30 to the valve housing opening B likewise associated with the first level 30, the valve housing opening C associated with the first level 30 to the valve housing opening D likewise associated with the first level 30, the valve housing opening E associated with the second level 38 to the valve housing opening F likewise associated with the second level 38. See FIGS. 4a and 4b in this regard.

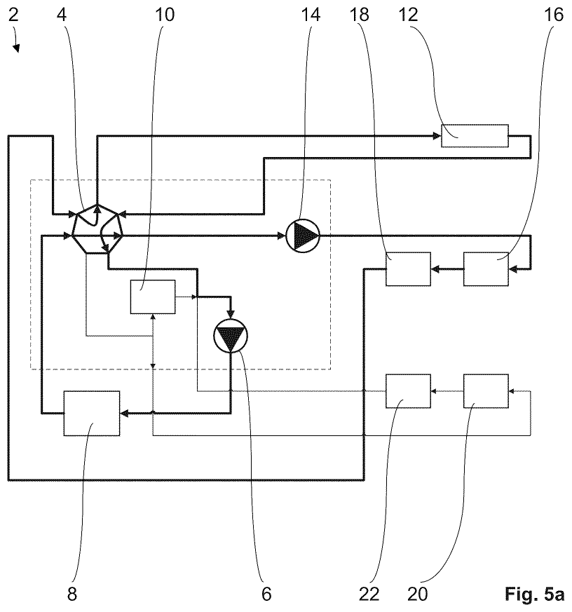

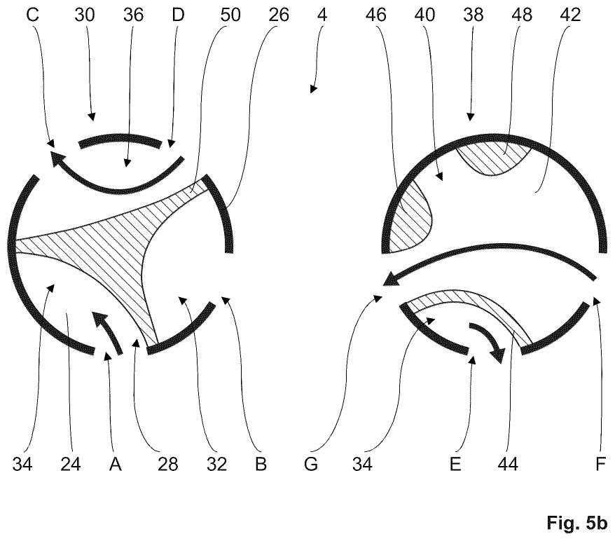

In the fifth switching state, the following valve housing openings are fluidically connected to one another: the valve housing opening A associated with the first level 30 to the valve housing opening E associated with the second level 38, the valve housing opening C associated with the first level 30 to the valve housing opening D likewise associated with the first level 30, the valve housing opening F associated with the second level 38 to the valve housing opening G likewise associated with the second level 38. See FIGS. 5a and 5b in this regard.

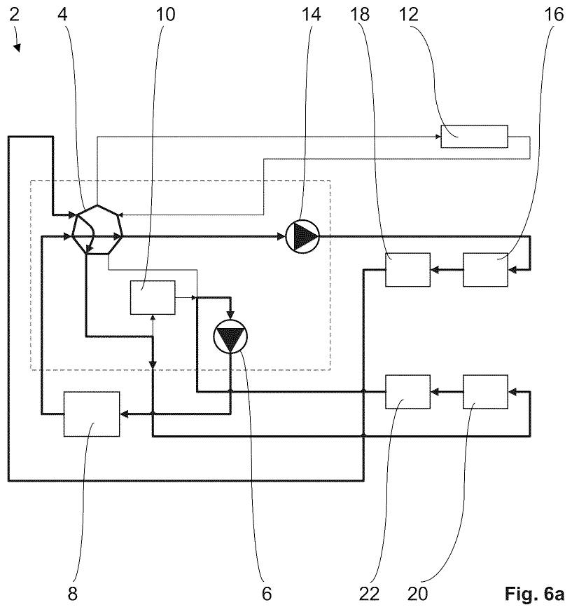

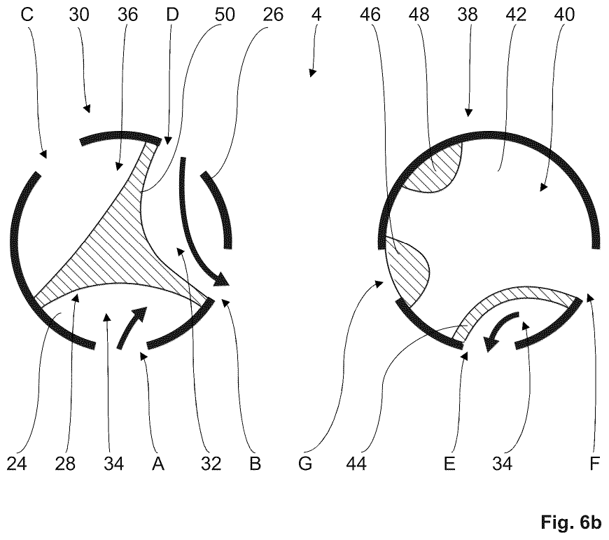

In the sixth switching state, the following valve housing openings are fluidically connected to one another: the valve housing opening A associated with the first level 30 to the valve housing opening E associated with the second level 38, the valve housing opening B associated with the first level 30 to the valve housing opening D likewise associated with the first level 30. See FIGS. 6a and 6b in this regard.

For the purpose of implementing one of the switching states of the valve 4, the valve body 28 and the two levels 30, 38 of the valve 4, which is designed as a central switching valve, are moved by a common shaft (not shown), namely rotated about the rotational axis in a manner known per se to the person skilled in the art. The valve 4 has the seven ports A to G with the following assignment: A as return from the traction battery 8; B as feed to the chiller 22; C as feed to the front radiator 12; D as return from the drive train, namely the power electronics 16 with the electric motor 18; E as feed to the drive train; F as return from the front radiator 12; G as return from the chiller 22 and as feed to the traction battery 8.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A valve for a fluid system of a vehicle, the valve comprising:
a valve housing having a base, a top, and a plurality of valve housing openings arranged in a side wall of the valve housing;
a valve body arranged in the valve housing so as to be rotatable about a rotational axis and having, arranged substantially perpendicular to the rotational axis, a first level that has at least one first connecting passage, and having, arranged substantially perpendicular to the rotational axis, a second level that is separated in terms of flow from the first level by an intermediate base and that has at least one second connecting passage for fluidically connecting at least two valve housing openings of the plurality of valve housing openings;
a valve seal that is arranged between the valve housing and the valve body and has valve seal openings corresponding to the valve housing openings; and
a valve actuating device for automatically rotating the valve body about the rotational axis,
wherein the at least one first and/or at least one second connecting passages is designed such that at least three valve housing openings associated with the same level as the connecting passage is adapted to be fluidically connected to one another via this connecting passage as a function of a switching state of the valve.

2. The valve according to claim 1, wherein three valve housing openings are associated with the level or wherein the three valve housing openings are associated only with the level.

3. The valve according to claim 1, wherein the connecting passage is delimited by at least one valve body wall, or wherein the at least one valve body wall is designed as three valve housing walls.

4. The valve according to claim 3, wherein the connecting passage is separated in terms of flow from at least one other connecting passage of the level via at least one of the at least one valve body walls, or wherein the valve body and the intermediate base are designed such that the connecting passage and/or the other connecting passage form a fluidic connection between the first level and the second level.

5. The valve according to claim 3, wherein at least one valve housing opening or four valve housing openings and at least one first connecting passage or three first connecting passages are associated with the first level, or wherein the three first connecting passages are separated from one another in terms of flow only by a single valve body wall, and wherein at least three valve housing openings and at least two connecting passages are associated with the second level or the second connecting passages are separated only by a single valve body wall.

6. The valve according to claim 1, wherein the valve body and the intermediate base are designed such that one of the first connecting passages and one of the second connecting passages are designed as a single, common connecting passage.

7. The valve according to claim 1, wherein at least two switching states are implemented via the valve, or wherein at least five switching states are implemented, wherein a transition of the valve from the first switching state ascending numerically to a sixth switching state takes place stepwise or steplessly by a rotation of the valve body in a first direction of a rotation by 36°, and a transition of the valve from the sixth switching state directly to the first switching state takes place through a rotation of the valve body in this first direction of rotation by 180°.

8. The valve according to claim 7, wherein the following valve housing openings are fluidically connected to one another in the first switching state: a valve housing opening A associated with the first level to a valve housing opening B associated with the first level, a valve housing opening C associated with the first level to a valve housing opening D associated with the first level, and a valve housing opening E associated with the second level to valve housing openings F and G that are associated with the second level.

9. The valve according to claim 7, wherein the following valve housing openings are fluidically connected to one another in the second switching state: a valve housing opening B associated with the first level to a valve housing opening D associated with the first level, and a valve housing opening E associated with the second level to a valve housing opening G likewise associated with the second level.

10. The valve according to claim 7, wherein the following valve housing openings are fluidically connected to one another in the third switching state: a valve housing opening B associated with the first level to a valve housing opening D associated with the first level, a valve housing opening C associated with the first level to a valve housing opening G associated with the second level, and a valve housing opening E associated with the second level to a valve housing opening F associated with the second level.

11. The valve according to claim 7, wherein the following valve housing openings are fluidically connected to one another in the fourth switching state: a valve housing opening A associated with the first level to a valve housing opening B associated with the first level, a valve housing opening C associated with the first level to a valve housing opening D associated with the first level, and a valve housing opening E associated with the second level to a valve housing opening F associated with the second level.

12. The valve according to claim 7, wherein the following valve housing openings are fluidically connected to one another in the fifth switching state: a valve housing opening A associated with the first level (30) to a valve housing opening E associated with the second level (38), a valve housing opening C associated with the first level (30) to a valve housing opening D likewise associated with the first level (30), a valve housing opening F associated with the second level (38) to a valve housing opening G likewise associated with the second level (38).

13. The valve according to claim 7, wherein the following valve housing openings are fluidically connected to one another in the sixth switching state: a valve housing opening A associated with the first level to a valve housing opening E associated with the second level, and a valve housing opening B associated with the first level to a valve housing opening D likewise associated with the first level.
